(19) United States
(12) Patent Application Publication
(10) Pub. No.: US 2013/0119859 A1
(43) Pub. Date: May 16, 2013

(54) GAS DISCHARGE LAMP AND MANUFACTURING METHOD THEREOF

(71) Applicants: Ming-Kai Hsu, Nantou City (TW); Jen-Hung Hsu, Toufen Township (TW)

(72) Inventors: Ming-Kai Hsu, Nantou City (TW); Jen-Hung Hsu, Toufen Township (TW)

(21) Appl. No.: 13/587,561

(22) Filed: Aug. 16, 2012

(30) Foreign Application Priority Data
Nov. 10, 2011 (TW) 100141123

(51) Int. Cl. H01J 61/36; H01J 61/04; H01J 9/00

(52) U.S. Cl. 313/631; 445/29

(57) ABSTRACT

A gas discharge lamp including a crystal tube, a connecting portion and a metal electrode rod is provided. The crystal tube includes at least one terminal portion and an axial segment. The terminal portion is located at an end of the axial segment. The connecting portion is constituted by N glass ring bands. The glass ring bands are connected to the terminal portion along the axial line in sequence. The first glass ring band connected to the terminal portion has a first coefficient of thermal expansion. The metal electrode rod is embedded in the terminal portion, and an end of the metal electrode rod away from the terminal portion is connected to the N^{th} glass ring band. The N^{th} glass ring band has a second coefficient of thermal expansion greater than the first coefficient of thermal expansion.

### CROSS-REFERENCE TO RELATED APPLICATION

This application claims the benefit of Taiwan application Serial No. 100141123, filed Nov. 10, 2011, the disclosure of which is incorporated by reference herein in its entirety.

### TECHNICAL FIELD

The technical field relates in general to a discharge lamp, and more particularly to a gas discharge lamp and a manufacturing method thereof.

### BACKGROUND

During the conventional process for manufacturing gas discharge lamp, the metal electrode and the quartz glass are connected together. However, since coefficient of thermal expansion of the quartz glass is very small, that is, about 5×10⁻⁷/° C. but the coefficient of thermal expansion of metal normally ranges between (45˜90)×10⁻⁷/° C., the quartz glass may easily crack and result in poor performance in air-proof if the quartz glass and the metal electrode are directly connected together. The crack of the quartz glass is mainly due to the big difference in the coefficients of thermal expansion between the metal electrode and the quartz glass. To resolve the above crack problem which occurs when bonding the metal electrode and quartz glass together, many bonding methods and bonding structures are provided. However, the associated manufacturing process is complicated and the yield rate of the manufacturing process is still not satisfactory.

### SUMMARY

The disclosure is directed to a gas discharge lamp and a manufacturing method thereof which achieve better air-proof effect with enhanced bonding strength.

According to one embodiment, a gas discharge lamp including a crystal tube, a connecting portion and a metal electrode rod is provided. The crystal tube includes at least one terminal portion and an axial segment. The terminal portion is located at an end of the axial segment. The connecting portion is constituted by N glass ring bands, wherein N is an integral equal to or greater than 4. The glass ring bands are connected to the terminal portion of the crystal tube along an axial line of the axial segment in sequence. The first glass ring band connected to the terminal portion has a first coefficient of thermal expansion. The metal electrode rod is embedded in the terminal portion, and an end of the metal electrode rod away from the terminal portion is connected to the N^{th} glass ring band. The N^{th} glass ring band has a second coefficient of thermal expansion greater than the first coefficient of thermal expansion.

According to another embodiment, a manufacturing method of a gas discharge lamp is provided. The method includes the following steps. Firstly, N glass ring bands are formed along an axial line of a crystal tube in sequence, wherein N is an integral equal to or greater than 4, and the first glass ring band connected to the terminal portion of the crystal tube has a first coefficient of thermal expansion. Then, a metal electrode rod is inserted into the crystal tube and the air inside the crystal tube is extracted, such that the N^{th} glass ring band and the metal electrode rod are thermo-bonded in vacuum, wherein the N^{th} glass ring band has a second coefficient of thermal expansion greater than the first coefficient of thermal expansion.

### BRIEF DESCRIPTION OF THE DRAWINGS

FIGS. 1A and 1B are a schematic view of a gas discharge lamp and a cross-sectional view of a gas discharge lamp along a V-V line according to an embodiment, respectively;

FIGS. 2A˜2D are procedures of a method for manufacturing a gas discharge lamp according to an embodiment; and

FIGS. 3A and 3B are a schematic view of a gas discharge lamp and a cross-sectional view of a gas discharge lamp along a V-V line according to another embodiment, respectively;

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a gas discharge lamp and a manufacturing method thereof disclosed in the present embodiment of the disclosure, N glass ring bands arranged along the axial line are sequentially connected between the crystal tube and the metal electrode rod, such that the metal electrode rod may be bonded and sealed in the crystal tube, wherein N is an integral equal to or greater than 4 for example. In an embodiment, the glass ring bands are ranked according to the magnitudes of the coefficients of thermal expansion. Therefore, the terminal portion of the crystal tube is connected to the glass ring band with smaller coefficient of thermal expansion, and the metal electrode rod is connected to the glass ring band with larger coefficient of thermal expansion, and better air-proof effect with enhanced bonding strength can thus be achieved.

A number of embodiments are disclosed below for elaborating the invention. However, the embodiments of the invention are for detailed descriptions only, not for limiting the scope of protection of the invention.

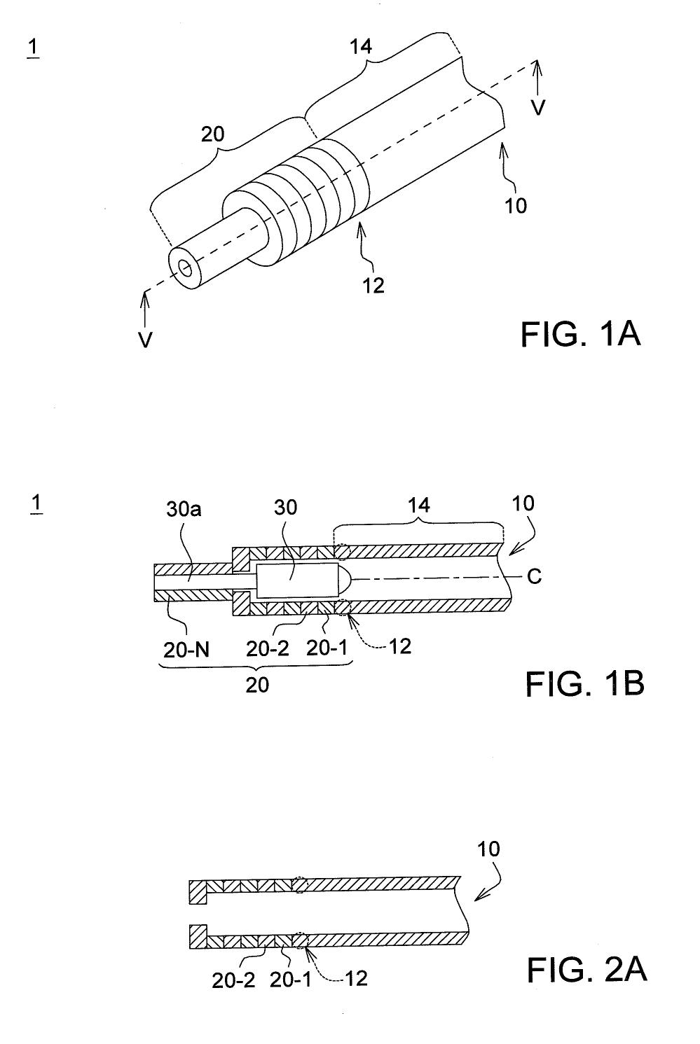

Referring to FIGS. 1A and 1B, a schematic view and a cross-sectional view of a gas discharge lamp along a V-V line according to an embodiment are shown, respectively. The gas discharge lamp 1 includes a crystal tube 10, a connecting portion 20 and a metal electrode rod 30. The crystal tube 10 includes a terminal portion 12 and an axial segment 14. The terminal portion 12 is located at the end of the axial segment 14. The axial segment 14 may be realized by a hollowed cylinder. The connecting portion 20 is constituted by N glass ring bands (only the designations 20-1, 20-2 and 20-N are illustrated), wherein N is an integral equal to or greater than 4. The glass ring bands are connected to the terminal portion 12 of the crystal tube 10 in sequence along an axial line C of the axial segment 14. The first glass ring band 20-1 connected to the terminal portion 12 has a first coefficient of thermal expansion.

In an embodiment, the first coefficient of thermal expansion such as ranges between 5×10⁻⁷/° C.˜15×10⁻⁷/° C. With respect to the coefficient of thermal expansion (5×10⁻⁷/° C.˜6×10⁻⁷/° C.) of the crystal tube 10, the coefficient of thermal expansion of the first glass ring band 20-1 is very close to the coefficient of thermal expansion of the crystal tube 10, hence avoiding the crystal tube 10 cracking due to repeated thermal stress.

Referring to Table 1, a comparison of coefficient of thermal expansion and softening temperature for four sequentially bonded glass ring bands is shown. The coefficient of thermal expansion of the first glass ring band 20-1 (No. 1) connected to the terminal portion 12 of the crystal tube 10 is about 10×10⁻⁷/° C. Those glass ring bands (No. 2˜4) farther away from the terminal portion 12 have larger coefficients of thermal expansion, which are respectively equal to 20×10⁻⁷/° C., 30×10⁻⁷/° C. and 39×10⁻⁷/° C. In addition, the difference in the coefficients of thermal expansion between two neighboring glass ring bands is about 10×10⁻⁷/° C.

TABLE 1

| | Coefficient Of | Softening |
|---|---|---|
| | Thermal Expansion | Temperature |
| Glass No. | (*10⁻⁷/°C.) | (°C.) |
| 1 | 10 | 1210 |
| 2 | 20 | 1190 |
| 3 | 30 | 1075 |
| 4 | 39 | 775 |

As indicated in FIG. 1B, after each glass ring band is connected, the metal electrode rod 30 is inserted into the crystal tube 10 and the air inside the crystal tube 10 is extracted to assure that the N^{th} glass ring band 20-N and the metal electrode rod 30 are thermo-bonded in vacuum and the metal electrode rod 30 will not be oxidized. Meanwhile, the N^{th} glass ring band 20-N will be heated to the softening temperature so as to be bonded and sealed with the metal electrode rod 30. The metal electrode rod 30 may be such as a tungsten rod or other electrode material.

In the present embodiment, the N^{th} glass ring band 20-N bonded with the metal electrode rod 30 has a second coefficient of thermal expansion. The second coefficient of thermal expansion ranges such as between 35×10⁻⁷/° C.˜45×10⁻⁷/° C. As shown in Table 1, the coefficient of thermal expansion of the N^{th} glass ring band 20-N (No. 4) is about 39×10⁻⁷/° C. With respect to the coefficient of thermal expansion of the metal electrode rod 30 which is 40×10⁻⁷/° C.˜45×10⁻⁷/° C., the coefficient of thermal expansion of the N^{th} glass ring band 20-N is very close to the coefficient of thermal expansion of the metal electrode rod 30, hence avoiding the crystal tube 10 cracking due to repeated thermal stress.

Referring to Table 2, a comparison of coefficient of thermal expansion and softening temperature for seven sequentially bonded glass ring bands is shown. The coefficient of thermal expansion of the first glass ring band 20-1 (No. 1) connected to the terminal portion 12 of the crystal tube 10 is about 10×10⁻⁷/° C. Those glass ring bands (No. 2˜7) farther away from the terminal portion 12 have larger coefficients of thermal expansion, which are respectively equal to 15×10⁻⁷/° C., 20×10⁻⁷/° C., 25×10⁻⁷/° C., 30×10⁻⁷/° C., 33×10⁻⁷/° C. and 39×10⁻⁷/° C. The difference between the coefficients of thermal expansion of two neighboring glass ring bands is about 3˜6×10⁻⁷/° C.

TABLE 2

| | Coefficient | |
|---|---|---|
| | Of Thermal | Softening |
| Glass No. | Expansion (*10⁻⁷/°C.) | Temperature (°C.) |
| 1 | 10 | 1210 |
| 2 | 15 | 1200 |
| 3 | 20 | 1190 |
| 4 | 25 | 1150 |
| 5 | 30 | 1075 |
| 6 | 33 | 825 |
| 7 | 39 | 775 |

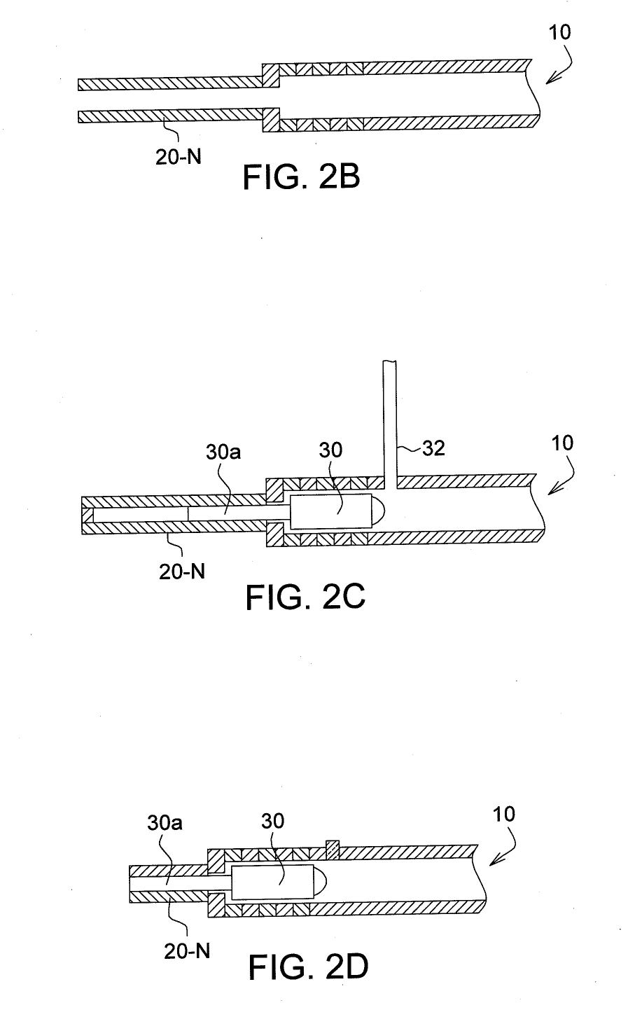

Referring to FIGS. 2A˜2D, procedures of a method for manufacturing a gas discharge lamp according to an embodiment are shown. First, N glass ring bands are formed in sequence along an axial line C of a crystal tube 10, wherein N is an integral equal to or greater than 4 for example, and the first glass ring band 20-1 connected to the terminal portion 12 of the crystal tube 10 has a first coefficient of thermal expansion. Then, a metal electrode rod 30 is inserted into the crystal tube 10, and the air inside the crystal tube 10 is extracted, such that the N^{th} glass ring band 20-N and the metal electrode rod 30 are thermo-bonded in vacuum. The N^{th} glass ring band 20-N has a second coefficient of thermal expansion larger than the first coefficient of thermal expansion. In an embodiment, if N is equal to or greater than 4, N−2^{th} glass ring band has a third coefficinet of thermal expansion larger than the first coefficinet of thermal expansion of the first glast ring band, and N−1^{th} glass ring band has a fourth coefficinet of thermal expansion larger than the third coefficinet of thermal expansion, and the second coefficient of thermal expansion of the N^{th} glass ring band is larger than the fourth coefficinet of thermal expansion. Therefore, the glass ring bands are ranked according to magnitudes of the coefficients of thermal expansion.

As shown in Table 1, the softening temperature of the first glass ring band 20-1 (No. 1) connected to the terminal portion 12 of the crystal tube 10 is about 1210° C. Those glass ring bands (No. 2˜4) farther away from the terminal portion 12 have lower softening temperatures, which are respectively equal to 1190° C., 1075° C. and 775° C. Therefore, the junction temperature for the terminal portion 12 of the crystal tube 10 and the first glass ring band 20-1 is about 1200° C., and the junction temperature for the metal electrode rod 30 and the N^{th} glass ring band 20-N is about 775° C.

Then, as indicated in FIG. 2B, the N^{th} glass ring band 20-N with smaller diameter is connected to the glass ring band with larger diameter arranged along the axial line, such that the diameter of the connecting portion 20 contracts inwardly and exactly accommodates the metal electrode rod 30. Therefore, an end (the axial portion 30a) of the metal electrode rod 30 may be inserted via the crystal tube 10 with larger diameter to be embedded in the N^{th} glass ring band 20-N with smaller diameter.

Then, as indicated in FIG. 2C, the vacuuming step includes the following sub-steps. First, the terminal end of the N^{th} glass ring band 20-N is sealed with hydrogen-oxygen flame. Next, a catheter 32 is inserted into the wall of the crystal tube 10 to extract the air off the crystal tube 10 until the degree of vacuum inside the crystal tube 10 is smaller than 5×10⁻⁵ torr. The metal electrode rod 30 is thermo-bonded with the N^{th} glass ring band 20-N under the circumstance that the crystal tube 10 is in the vacuum state. After the crystal tube is bonded and sealed, the catheter 32 is removed, and the hole on the glass wall is melted and sealed to assure that the interior of the crystal tube 10 is in the vacuum state as indicated in FIG. 2D. The pressure test shows that the final product of the gas discharge lamp 1 is able to resist at least 30 atmospheres.

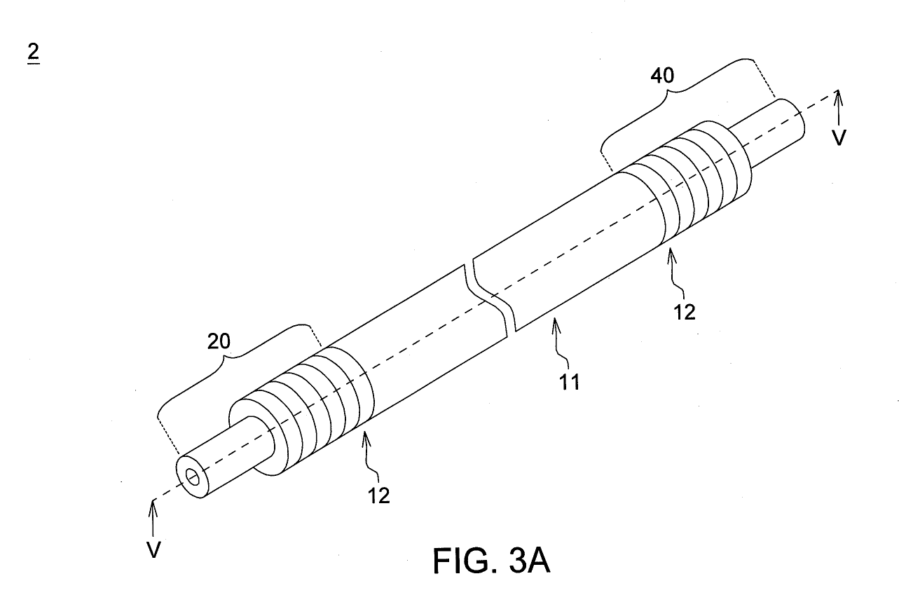

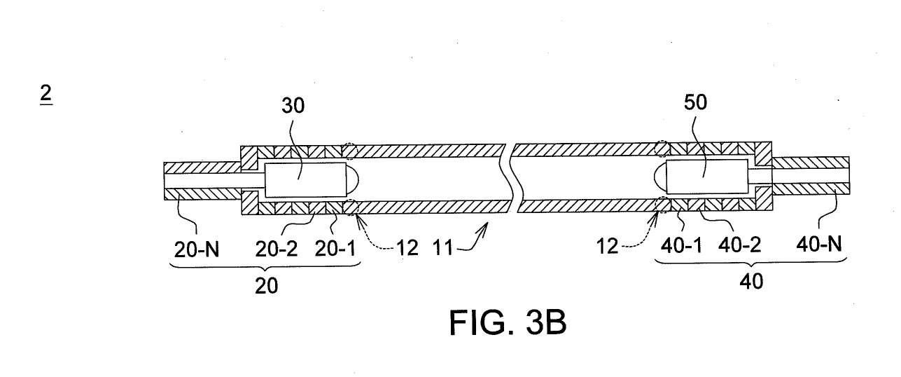

Referring to FIGS. 3A and 3B, a schematic view and a cross-sectional view of a gas discharge lamp along a V-V line according to another embodiment are shown, respectively. The gas discharge lamp 2 of the present embodiment has a first metal electrode rod 30 and a second metal electrode rod 50 disposed at two terminal portions 12 of the crystal tube 11, and the first metal electrode rod 30 and the second metal electrode rod 50 are respectively sealed and connected to the two connecting portions 20 and 40. The crystal tube 11, after being sealed, is filled with a discharge gas such as xenon. Before xenon is infused into the crystal tube 11, the degree of vacuum inside the crystal tube 11 is smaller than 5×10⁻⁶ torr to assure that the two metal electrode rods 30 and 50 and the crystal tube 11 are bonded and air-proofed. The arrangement and constitution of the glass ring bands (only the designations 40-1, 40-2 and 40-N are illustrated) of the connecting portion 40 are identical to that of glass ring bands of the connecting portion 20. Detailed descriptions are already disclosed in FIG. 1, Table 1 and Table 2, and are not repeated here.

According to the gas discharge lamp and the manufacturing method thereof disclosed in the above embodiments of the disclosure, N glass ring bands arranged along the axial line are connected in sequence between the crystal tube and the metal electrode rod, such that the metal electrode rod may be bonded and sealed in the crystal tube. Since the terminal portion of the crystal tube is connected to the glass ring band with smaller coefficient of thermal expansion, and the metal electrode rod is connected to the glass ring band with larger coefficient of thermal expansion, better air-proof with enhanced bonding strength can thus be achieved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A gas discharge lamp, comprising:
a crystal tube, comprising at least one terminal portion and an axial segment, wherein the terminal portion is located at an end of the axial segment;
a connecting portion comprising N glass ring bands, wherein N is a positive integral, the glass ring bands are connected to the terminal portion of the crystal tube along an axial line of the axial segment in sequence, and the first glass ring band connected to the terminal portion has a first coefficient of thermal expansion; and
a metal electrode rod located in the crystal tube, wherein an end of the metal electrode rod away from the terminal portion is connected to the N^{th} glass ring band, and the N^{th} glass ring band has a second coefficient of thermal expansion greater than the first coefficient of thermal expansion.

2. The gas discharge lamp according to claim 1, wherein the glass ring bands are ranked according to magnitudes of the coefficients of thermal expansion.

3. The gas discharge lamp according to claim 1, wherein the difference in the coefficients of thermal expansion between two neighboring glass ring bands is smaller than or equal to 10×10⁻⁷/° C.

4. The gas discharge lamp according to claim 1, wherein the first coefficient of thermal expansion ranges between 5×10⁻⁷/° C.˜15×10⁻⁷/° C.

5. The gas discharge lamp according to claim 1, wherein the second coefficient of thermal expansion ranges between 35×10⁻⁷/° C.˜45×10⁻⁷/° C.

6. The gas discharge lamp according to claim 1, wherein the metal electrode rod is a tungsten rod.

7. The gas discharge lamp according to claim 1, wherein if N is an integral equal to or greater than 4, N−2^{th} glass ring band has a third coefficinet of thermal expansion larger than the first coefficinet of thermal expansion of the first glast ring band, and N−1^{th} glass ring band has a fourth coefficinet of thermal expansion larger than the third coefficinet of thermal expansion, and the second coefficient of thermal expansion of the N^{th} glass ring band is larger than the fourth coefficinet of thermal expansion.

8. A manufacturing method of a gas discharge lamp, comprising:
forming N glass ring bands along an axial line of a crystal tube in sequence, wherein N is a positive integral equal to or greater than 4, and the first glass ring band connected to the terminal portion of the crystal tube has a first coefficient of thermal expansion; inserting a metal electrode rod into the crystal tube and extract the air off the crystal tube, such that the N^{th} glass ring band and the metal electrode rod are thermo-bonded in vacuum, wherein the N^{th} glass ring band has a second coefficient of thermal expansion greater than the first coefficient of thermal expansion.

9. The manufacturing method of the gas discharge lamp according to claim 8, wherein the glass ring bands are ranked according to magnitudes of the coefficients of thermal expansion.

10. The manufacturing method of the gas discharge lamp according to claim 8, wherein the difference in the coefficients of thermal expansion between two neighboring glass ring bands is smaller than or equal to 10×10⁻⁷/° C.

11. The manufacturing method of the gas discharge lamp according to claim 8, wherein the first coefficient of thermal expansion ranges between 5×10⁻⁷/° C.˜15×10⁻⁷/° C.

12. The manufacturing method of the gas discharge lamp according to claim 8, wherein the second coefficient of thermal expansion ranges between 35×10⁻⁷/° C.˜45×10⁻⁷/° C.

13. The manufacturing method of the gas discharge lamp according to claim 8, wherein the junction temperature for the terminal portion and the first glass ring band is higher than or equal to 1200° C.

14. The manufacturing method of the gas discharge lamp according to claim 8, wherein the junction temperature for the metal electrode rod and the N^{th} glass ring band is lower than 800° C.

15. The manufacturing method of the gas discharge lamp according to claim 8, wherein if N is an integral equal to or greater than 4, N−2^{th} glass ring band has a third coefficinet of thermal expansion larger than the first coefficinet of thermal expansion of the first glast ring band, and N−1^{th} glass ring band has a fourth coefficinet of thermal expansion larger than the third coefficinet of thermal expansion, and the second coefficient of thermal expansion of the N^{th} glass ring band is larger than the fourth coefficinet of thermal expansion.
